(19) United States
(12) Patent Application Publication
(10) Pub. No.: US 2013/0036975 A1
(43) Pub. Date: Feb. 14, 2013

(54) METHOD OF AUTOMATICALLY MILKING ANIMALS AND AUTOMATIC MILKING SYSTEM

(71) Applicant: Peter Carlsson, Huddinge (SE)

(72) Inventor: Peter Carlsson, Huddinge (SE)

(73) Assignee: DELAVAL HOLDING AB, Tumba (SE)

(21) Appl. No.: 13/638,664

(22) PCT Filed: May 30, 2011
(86) PCT No.: PCT/EP11/58841

§ 371 Date: Oct. 1, 2012

Related U.S. Application Data
(60) Provisional application No. 61/350,235, filed on Jun. 1, 2010.

(30) Foreign Application Priority Data
Jun. 1, 2010 (SE) 1050549-3

(51) Int. Cl. A01J 5/007; A01J 5/01

(52) U.S. Cl. 119/14.08; 119/14.02

(57) ABSTRACT

An automatic milking system (11) includes i) a milking apparatus (12) with teat cups (15a-d) and milk flow rate measuring equipment (16a-d) for measuring the individual milk flow from each of the teats of the animal; and ii) a teat-cup device (14) attaching the teat cups to the teats of the animal prior to milking the animal. The milk flow measuring equipment is arranged to measure the individual milk flow rate from each of the teats of the animal continuously during the milking of the animal. The teat-cup device (14) is operatively connected to the flow measuring equipment and is arranged, for each of the teats of the animal, to take off the teat cup from the teat of the animal depending on (i) the measured individual milk flow from the teat of the animal falling below a first threshold value (TV1) and (ii) the measured individual milk flow from each of the teats of the animal being below a second threshold value (TV2), whichever occurs first, wherein the second threshold value is higher than the first threshold value.

### TECHNICAL FIELD OF THE INVENTION

The present invention generally relates to dairy farming and to milking of dairy animals therein. Particularly, the invention relates to an improved method of automatically milking animals and to an automatic milking system wherein the method is implemented.

### DESCRIPTION OF RELATED ART AND BACKGROUND OF THE INVENTION

In modern dairy farm industry there are continuous research and development activities in order to improve the efficiency of milking equipment. Key targets are higher milk yields and shorter milking times.

A major trend in this respect is an increased degree of automation of the various activities. For instance, machine milking may be performed by milking robots in a completely automated manner. Such an automatic milking system may take care of milking, feeding, milk inspection, milk sampling, animal traffic, etc. in a large area wherein the dairy animals are walking about freely and are visiting the milking machine voluntarily.

An automatic milking system involves heavy expenditure and has a limited milk production capacity. How to operate and use such a milking system, which animals are visiting on a voluntary basis, in order to obtain an overall optimized dairy farm performance is an arduous task. Naturally, not only the milk yields and the milking times have to be considered, but ethical aspects and animal care are important factors.

In the DeLaval voluntary milking system the milk flow from each of the teats of an animal being milked is continuously monitored during the milking, and each of the teat cups is taken off individually when the individual milk flow drops below a set threshold value such as e.g. 210 g/min. It has been suggested to raise the threshold value as a means for shortening the milking time. However, this would also lead to corresponding losses in the milk yield.

### SUMMARY OF THE INVENTION

It is an object of the present invention to provide a method of automatically milking animals and an automatic milking system, by which the overall milk production can be optimized.

It is a further object to provide such method and such milking system, by which the milking times can be shortened and the milk yield can be increased.

It is yet a further object to provide such method and such milking system, which are simple, robust, reliable, accurate, precise, cost-efficient, and easy to use.

These objects, among others, are according to the present invention attained by methods of milking animals and automatic milking systems as claimed in the appended claims.

According to a first aspect of the invention a method of milking animals is provided, according to which teat cups are attached to the teats of an animal, the animal is milked, the individual milk flow from each of the teats of the animal is measured continuously during the milking, and, for each of the teats of the animal, the corresponding teat cup is detached from the teat of the animal in a latter part of the milking depending on the first occurring one of the following scenarios:

(i) the measured individual milk flow from the teat of the animal falls below a first threshold value,
(ii) the measured individual milk flow from each of the teats of the animal is below a second threshold value.

The second threshold value is higher, preferably considerably higher, than the first threshold value.

Advantageously, the detachment of each of the teat cups is performed immediately when either one of the two scenarios occurs, but there may be a certain time delay before detachment is performed.

The first threshold value may be between about 100 g/min and about 300 g/min, more preferably between about 150 g/min and about 250 g/min, and the second threshold value may be between about 300 g/min and about 700 g/min, more preferably between about 400 g/min and about 600 g/min.

The algorithm regarding the take-off depending on the first threshold value is performed today according to the prior art. However, this algorithm is now modified by detaching teat cups earlier in some situations. That is, if the measured individual milk flow from each of the teats of the animal is below a second threshold value, milking is finished and the teat cups that are still attached are detached, irrespective of whether any measured individual milk flow has dropped below the first threshold. This may be the case for one, two, three, or all four teats of the animal (provided that the animal has four teats).

As a result the milking time can be shortened, while minimizing the loss in milk yield, and the daily milk yield of the milking machine can be increased, since the milking machine is sooner ready to milk a following animal.

In order to ensure that the teat cups are detached in the latter part of the milking, and in order to avoid too early detachment the teat cups, e.g. in case of problems to commence the milking adequately, a timer may be set in connection with (i) the attachment of the teats cups to the teats of the animal or (ii) the commencement of the milking of the animal, and no one of the teat cups are detached before the timer has expired.

The above algorithm may be further modified to further shorten the milking time in some situations. If the individual milk flow from one of the teats has not dropped to the second threshold value when the individual milk flow from each of the other teats has dropped below the first threshold value, the teat cup attached to this teat is detached either immediately or after a time delay, irrespective of the individual milk flow from this teat. In other words, the two last teat cups to be detached from the teats of the animals are typically detached at the same time. Hereby the overall milking time of the animal can be further shortened.

According to a second aspect of the invention, an automatic milking system, in which the above method is implemented, is provided. The automatic milking system, which may be a voluntary milking system, comprises a milking apparatus with teat cups, a device provided for attaching teat cups such as e.g. a milking robot, and a teat cup detachment mechanism. The device provided for attaching teat cups is arranged to attach the teat cups to the teats of an animal to be milked, and the milking apparatus is arranged to subsequently milk the animal. The milking apparatus includes milk flow measuring equipment arranged to continuously measure the individual milk flow from each of the teats of the animal during the milking. The teat cup detachment mechanism is operatively connected to the flow measuring equipment and is arranged, for each of the teats of the animal, to detach the teat cup from the teat of the animal in a latter part of the milking depending on the first occurring one of the following scenarios: (i) the measured individual milk flow from the teat of the animal falls below a first threshold value, and (ii) the measured individual milk flow from each of the teats of the animal is below a second threshold value, wherein the second threshold value is higher than the first threshold value.

The teat cup detachment mechanism may simply be a switch for switching off the vacuum from the respective teat cups, whereupon the respective teat cups fall off the respective teats by means of gravity. If desirable a milking robot or similar may assist during the teat cup detachment, or the teat cups can be detached by automatic mechanisms in the teat cup magazine which pull the hoses connected to the teat cups.

### BRIEF DESCRIPTION OF THE DRAWINGS

The present invention will become fully understood from the detailed description of embodiments of the present invention given herein below and the accompanying FIGS. 1-2, which are given by way of illustration only, and thus are not limitative of the present invention.

FIG. 1 displays schematically an automatic milking system according to an embodiment of the present invention.

FIG. 2 displays schematically a diagram in which the individual milk flow from each teat of an animal being milked is set out against time during milking according to an embodiment of the invention.

### DETAILED DESCRIPTION OF EMBODIMENTS

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known techniques are omitted so as not to obscure the description of the present invention with unnecessary details.

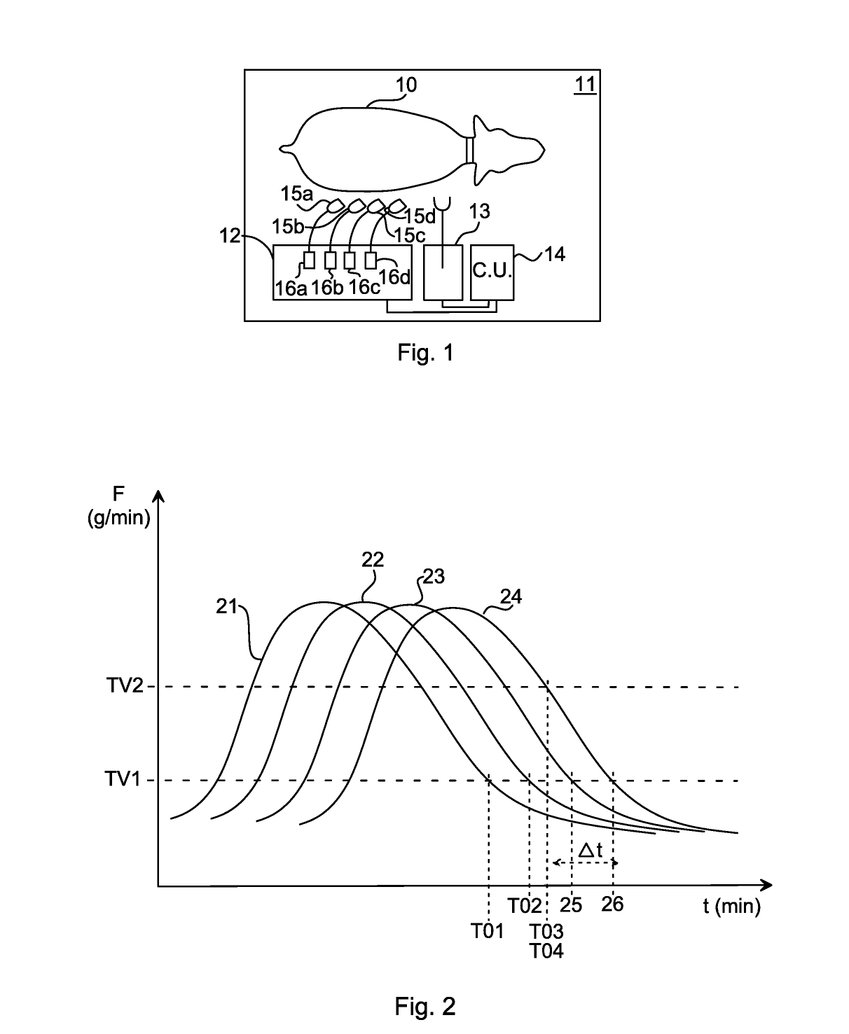

FIG. 1 displays schematically an automatic milking system 11 according to an embodiment of the present invention. The automatic milking system 11, which may be a voluntary milking system, comprises a milking apparatus 12, which includes teat cups 15a-d and milk flow measuring equipment 16a-d capable of measuring the individual milk flow from each of the teats of an animal 10 present in the milking system 11. A milking robot 14 is arranged to attach the teat cups 15a-d to the teats of the animal 10 prior to milking. The milking apparatus 12 is arranged to subsequently milk the animal 10 by supplying vacuum to the teat cups 15a-d in a manner known to a person skilled in the art. Simultaneously, the milk flow measuring equipment, which advantageously includes four flow meters 16a-d, is arranged to continuously measure the individual milk flow from each of the teats of the animal 10. After milking, the teat cups 15a-d are detached from the teats of the animal 10 in any manner known to a person skilled in the art. Conveniently, the vacuum supplied to the teat cups 15a-d is switched off, or at least considerably lowered, and as a result the teat cups 15a-d fall off the teats of the animal 10 by means of gravity, and can be retracted by an arrangement provided for this (not explicitly illustrated). The teat cup detachment can additionally be assisted by the milking robot 13 or any other arrangement known in the art.

The teat cup attachment, milking, and teat cup detachment are controlled by a control unit 14 operatively connected to the milking robot 13 and the milking apparatus 12 with its milk flow measuring equipment 16a-d.

The control unit 14 is, for each of the teats of the animal 10, arranged to control the milking apparatus 12, and optionally the milking robot 13, to detach the teat cup 15a-d from the teat of the animal 10 depending on whether one of two scenarios occurs.

The two scenarios are: (i) the measured individual milk flow from the teat of the animal 10 drops below a first threshold value, and (ii) the measured individual milk flow from each of the teats of the animal 10 is below a second threshold value.

FIG. 2 displays schematically an exemplary diagram in which the milk flow F from each teat of an animal is set out against time t during milking with the above algorithm implemented. The first and second threshold values are denoted by TV1 and TV2. The different milk flow curves are denoted by 21, 22, 23, and 24.

The second threshold TV2 value is set to be higher than the first threshold value TV1. Advantageously, the first threshold value is between about 100 g/min and about 300 g/min, more preferably between about 150 g/min and about 250 g/min, and the second threshold value is between about 300 g/min and about 700 g/min, more preferably between about 400 g/min and about 600 g/min. In a typical exemplary embodiment of the invention, the first threshold value TV1 is set to about 210 g/min and the second threshold value TV2 is set to about 500 g/min.

By means of the second conditional scenario above, i.e. that each of the teat cups 15a-d will be taken off if the measured individual milk flows from all the teats of the animal 10 are each below the second threshold value TV2 even if the measured individual milk flow from the teat of the animal 10 has not dropped below the first threshold value TV1, the milking time will in some situations be shortened.

Consider for instance the diagram of FIG. 2. The individual milk flow 21 from a first teat falls below the first threshold TV1 at a point of time TO1, which occurs before the individual milk flows 21, 22, 23, 24 from all teats are each below the second threshold value TV2. Consequently, teat cup detachment for the first teat is performed at the point of time TO1. Similarly, the individual milk flow 22 from a second teat falls below the first threshold TV1 at a point of time TO2, which occurs before the individual milk flows 21, 22, 23, 24 from all teats are below the second threshold value TV2. Consequently, teat cup detachment for the second teat is performed at the point of time TO2. At the point of time TO3 the individual milk flows 21, 22, 23, 24 from all teats are each below the second threshold value TV2, and this occurs before the point of time 25, at which the individual milk flow 23 from a third teat falls below the first threshold TV1, and before the point of time 26, at which the individual milk flow 24 from a fourth teat falls below the first threshold TV1. Consequently, teat cup detachments of the third and fourth teats are performed simultaneously at the point of time TO3.

Thus, if the second conditional scenario had not been implemented in the algorithm, the last teat cup detachment had been performed at the point of time 26, which means that the milking time has for this example been shortened by Δt=26−TO3 by means of the addition of the second conditional scenario.

Simulations based on 59 000 actual milkings collected from four different farms consistently indicate that the direct milk flow (yield/machine on-time) would increase by 4-5% by the introduction of the second conditional scenario of the above depicted algorithm. The freed machine on-time can be used for either more frequent milking of the animals served by the automatic milking system or for the addition of further animals to be served by the automatic milking system.

While it is preferred that, for each of the teats of the animal, the teat cup 15a-d is taken off the teat of the animal 10 immediately when any of the above two scenarios occurs, the detachment may alternatively be performed when a time period has lapsed after any of the above two scenarios has occurred.

In order to ensure that the teat cup detachment is performed in a latter stage of the milking and not too early, e.g. in cases where the milk flow does not increase normally, a timer may be set in connection with the attachment of the teats cups 15a-d to the teats of the animal 10 or in connection with the start of the milking of the animal 10, and none of the teat cups 15a-d are taken off before the timer has expired.

In a modified version of the invention, for each of the teats of the animal 10, the teat cup 15a-d attached to the teat of the animal 10 is detached depending on whether, preferably immediately when, the measured individual milk flows from the other teats of the animal 10 have each fallen below the first threshold value TV1, provided that this occurs before the measured individual milk flow from the teat of the animal 10 falls below the first threshold value TV1 and the measured individual milk flows from all the teats of the animal 10 are each below the second threshold value TV2. Hereby, in some situations, the milking time will be further shortened as the two last remaining teat cups to be detached are detached at the same time irrespective of whether the milk flow from a teat attached one of the teat cups has not even dropped to the second threshold value TV2.

The invention relates also to a computer program product loadable into the internal memory of the control unit 14 of the automatic milking system 11 and comprising software code portions for controlling the inventive teat cup detachment algorithm when the product is run on the control unit 14.

It will be obvious that the invention may be varied in a plurality of ways. Such variations are not to be regarded as a departure from the scope of the invention. All such modifications as would be obvious to one skilled in the art are intended to be included within the scope of the appended claims.

1-15. (canceled)

16. A method of automatically milking animals comprising the steps of:
a device (14) attaching teat cups (15a-d) to the teats of an animal (10);
milking the animal using the attached teat cups (15a-d);
using milk flow rate measuring equipment (16a-d), measuring, continuously during the milking, individual milk flow rates from each of the teats of the animal; and
the device (14), for each one of the teats of the animal, taking off the teat cup from the teat of the animal based on a first occurrence of at least one of:
(i) a first scenario of the measured individual milk flow rate from the one teat of the animal falls below a first threshold value (TV1), and
(ii) a second scenario of the measured individual milk flow rate from all of the teats of the animal are each below a second threshold value (TV2),
wherein the second threshold value (TV2) is higher than the first threshold value (TV1).

17. The method of claim 16, wherein for each of the teats of the animal, the teat cup is taken off the teat of the animal immediately based on the first occurrence of the first scenario and the second scenario.

18. The method of claim 16, wherein for each of the teats of the animal, the teat cup is taken off the teat of the animal at a certain specified time delay after the first occurrence of the first scenario and the second scenario.

19. The method of claim 16, comprising the further step of:
setting a timer in connection with one of (i) the attachment of the teats cups to the teats of the animal, and (ii) commencement of the milking of the animal,
wherein none of the teat cups are taken off before the timer has expired.

20. The method of claim 17, comprising the further step of:
setting a timer in connection with one of (i) the attachment of the teats cups to the teats of the animal, and (ii) commencement of the milking of the animal,
wherein none of the teat cups are taken off before the timer has expired.

21. The method of claim 18, comprising the further step of:
setting a timer in connection with one of (i) the attachment of the teats cups to the teats of the animal, and (ii) commencement of the milking of the animal,
wherein none of the teat cups are taken off before the timer has expired.

22. The method of claim 16, wherein, for each of the teats of the animal, the teat cup attached to the teat of the animal is taken off when the measured individual milk flow rate from each of the other teats of the animal falls below the first threshold value occurs before i) the measured individual milk flow rate from the teat of the animal falls below the first threshold value and ii) the measured individual milk flow rate from all of the teats of the animal is below the second threshold value.

23. The method of any of claim 16, wherein,
the first threshold value is between about 100 g/min and about 300 g/min, and
the second threshold value is between about 300 g/min and about 700 g/min.

24. The method of any of claim 16, wherein,
the first threshold value is between about 150 g/min and about 250 g/min, and
the second threshold value is between about 400 g/min and about 600 g/min.

25. The method of claim 16, wherein the method is implemented in a voluntary milking system provided with a milking robot for attaching the teat cups to the teats of the animal.

26. A non-transitory computer readable medium having recorded thereon a computer program product loadable into an internal memory of a computer of an automatic milking system, and comprising software code portions, when executed on the computer, for controlling the computer to perform the steps of:
attaching teat cups (15a-d) to the teats of an animal (10);
milking the animal with the attached teat cups (15a-d);
measuring, continuously during the milking, individual milk flow rates from each of the teats of the animal; and
for each one of the teats of the animal, taking off the teat cup from the teat of the animal based on a first occurrence of at least one of:
(i) a first scenario of the measured individual milk flow rate from the one teat of the animal falls below a first threshold value (TV1), and
(ii) a second scenario of the measured individual milk flow rate from all of the teats of the animal are each below a second threshold value (TV2),
wherein the second threshold value (TV2) is higher than the first threshold value (TV1).

27. An automatic milking system (11) for milking animals, the system comprising:
a milking apparatus (12) for milking an animal (10), the milking apparatus including teat cups (15a-d) and milk flow rate measuring equipment (16a-d) arranged for measuring individual milk flow rates from each of the teats of the animal being milked; and
a device (14) attaching the teat cups to the teats of the animal prior to milking the animal, wherein,
the milk flow rate measuring equipment (16a-d), measures, continuously during the milking, the individual milk flow rates from each of the teats of the animal; and
the device (14), for each one of the teats of the animal, takes off the teat cup from the teat of the animal based on a first occurrence of at least one of:
(i) a first scenario of the measured individual milk flow rate from the one teat of the animal falls below a first threshold value (TV1), and
(ii) a second scenario of the measured individual milk flow rate from all of the teats of the animal are each below a second threshold value (TV2),
wherein the second threshold value (TV2) is higher than the first threshold value (TV1).

28. The automatic milking system of claim 27, wherein the device is configured to, for each of the teats of the animal, take the teat cup off the teat of the animal immediately based on the first occurrence of the first scenario and the second scenario.

29. The automatic milking system of claim 27, wherein the device is configured to, for each of the teats of the animal, take the teat cup off the teat of the animal at a certain specified time delay after the first occurrence of the first scenario and the second scenario.

30. The automatic milking system of claim 27, further comprising:
a timer, the timer set in connection with one of (i) the attachment of the teats cups to the teats of the animal, and (ii) commencement of the milking of the animal,
wherein the device is configured so that none of the teat cups are taken off before the timer has expired.

31. The automatic milking system of claim 27, wherein the device is configured so that, for each of the teats of the animal, the teat cup attached to the teat of the animal is taken off when the measured individual milk flow rate from each of the other teats of the animal falls below the first threshold value occurs before i) the measured individual milk flow rate from the teat of the animal falls below the first threshold value and ii) the measured individual milk flow rate from all of the teats of the animal is below the second threshold value.

32. The automatic milking system of claim 27, wherein,
the first threshold value is between about 100 g/min and about 300 g/min, and
the second threshold value is between about 300 g/min and about 700 g/min.

33. The automatic milking system of claim 27, wherein,
the first threshold value is between about 150 g/min and about 250 g/min, and
the second threshold value is between about 400 g/min and about 600 g/min.

34. The automatic milking system of claim 27, wherein the automatic milking system is a voluntary milking system and the device attaching the teat cups includes a milking robot.
